(19) United States
(12) Patent Application Publication
(10) Pub. No.: US 2008/0004880 A1
(43) Pub. Date: Jan. 3, 2008

(54) PERSONALIZED SPEECH SERVICES ACROSS A NETWORK

(75) Inventors: Alex Acero, Remond, WA (US); Timothy S. Paek, Redmond, WA (US); Christopher A. Meek, Redmond, WA (US); David M. Chickering, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/424,459

(22) Filed: Jun. 15, 2006

(51) Int. Cl. G10L 21/00

(52) U.S. Cl. 704/270.1

(57) ABSTRACT

A speech application accessible across a network is personalized for a particular user based on preferences for the user. The speech application can be modified based on the preferences.

### BACKGROUND

The discussion below is merely provided for general background information and is not intended to be used as an aid in determining the scope of the claimed subject matter.

Personal digital assistants (PDA), mobile devices and phones are used with ever increasing frequency by people in their day-to-day activities. With the increase in processing power now available for microprocessors used to run these devices, the functionality of these devices is increasing, and in some cases, merging. For instance, many portable phones now can be used to access and browse the Internet as well as can be used to store personal information such as addresses, phone numbers and the like.

In view that these computing devices are being used with increasing frequency, it is beneficial to provide an easy interface for the user to enter information into the computing device and/or access information across a network using the device. Unfortunately, due to the desire to keep these devices as small as possible in order that they are easily carried, conventional input methods and accessing tasks are limited due to the limited surface area available on housings of the devices.

### SUMMARY

The Summary and Abstract are provided to introduce some concepts in a simplified form that are further described below in the Detailed Description. The Summary and Abstract are not intended to identify key features or essential features of the claimed subject matter, nor is it intended to be used as an aid in determining the scope of the claimed subject matter.

A speech application accessible across a network is personalized for a particular user based on preferences for the user. The speech application can be modified based on the preferences.

### BRIEF DESCRIPTION OF THE DRAWINGS

FIG. 1 is a block diagram of a network-based service environment.

FIG. 2 is a block diagram of a communication architecture.

FIG. 3 is a block diagram of a speech application.

FIG. 4 is a block diagram of a speech recognizer.

FIG. 5 is a flow chart of a method for altering a speech application.

FIG. 6 is a block diagram of a general computing environment.

FIG. 7 is a block diagram of a mobile computing device.

FIG. 8 is a plan view of a phone.

### DETAILED DESCRIPTION

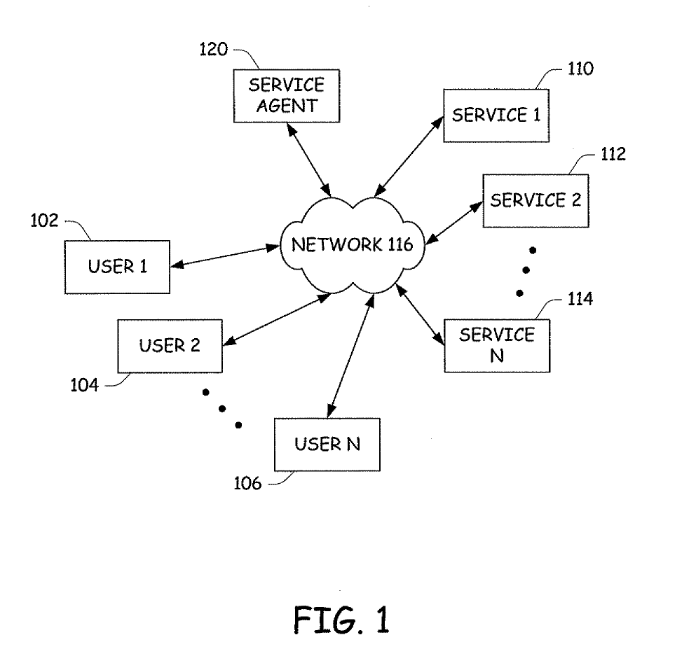

FIG. 1 is a block diagram of a network-based service environment 100. Service environment 100 includes a plurality of users, for example user 102, user 104 and user 106. Each of the plurality of users 102, 104 and 106 can access a plurality of services, for example services 110, 112 and 114 through a network 116. Additionally, each of the users 102, 104 and 106 can connect with other users through network 116. The users 102, 104 and 106 can connect with service agent 120 through network 116.

Service agent 120 can store information related to each of the users 102, 104 and 106 as well as facilitate communication among each of the users 102, 104, 106 and each of the services 110, 112 and 114. Services 110, 112 and 114 can provide various sources of information for access by users 102, 104 and 106. For example, information can relate to stock quotes, weather, travel information, news, music, advertisements, etc. Service agent 120 can include personal information for each of the users 102, 104 and 106 to customize access to services 110, 112 and 114. For example, user 102 may wish to only receive particular stock quotes from service 112. Service agent 120 can store this information.

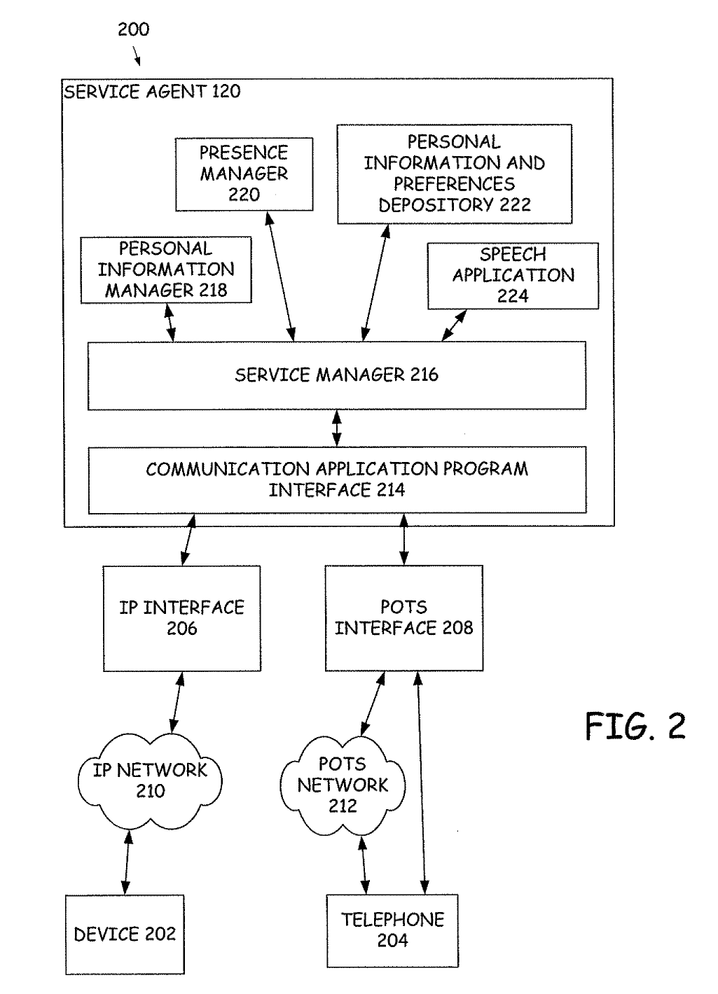

FIG. 2 illustrates an exemplary communication architecture 200 with a service agent 120 as discussed above. In one embodiment, service agent 120 can be implemented on a general purpose computer. Agent 120 receives communication requests and messages from a user (for example users 102, 104 and 106) and performs tasks based on the requests and messages. The messages can be routed to a destination. The user can access agent 120 through any device, telephone, remote personal information manager, etc. that can connect to agent 120.

Information from the user can take many forms including web-based data entry, real time voice (for example from a simple telephone or through a voice over Internet protocol source), real time text (such as instant messaging), non-real time voice (for example a voicemail message) and non-real time text (for example through short message service (SMS) or email). Tasks are automatically performed by agent 120, for example speech recognition, accessing services, scheduling a calendar, voice dialing, managing contact information, managing messages, call routing and interpreting a caller identification.

Agent 120 represents a single point of contact for a user or a group of users. Thus, if a person wishes to contact a user or group of users, communication requests and messages are passed through agent 120. In this manner, the person need not have all contact information for another user or group of users. The person only needs to contact agent 120, which can handle and route incoming communication requests and messages. Additionally, agent 120 is capable of initiating a dialog with the person, if the user or group of users is unavailable.

A user can contact agent 120 through a number of a different modes of communication. Generally, agent 120 can be accessed through a computing device 202 (for example a mobile device, laptop or desktop computer, which herein represents various forms of computing devices having a display screen, a microphone, a camera, a touch sensitive panel, etc., as required based on the form of input), or through a phone 204 wherein communication is made audibly or through tones generated by phone 204 in response to keys depressed and wherein information from agent 120 can be provided audibly back to the user.

More importantly though, agent 120 is unified in that whether information is obtained through device 202 or phone 204, agent 120 can support either mode of operation. Agent 120 is operably coupled to multiple interfaces to receive communication messages. IP interface 206 receives information using packet switching technologies, for example using TCP/IP (Transmission Control Protocol/Internet Protocol). POTS (Plain Old Telephone System, also referred to as Plain Old Telephone Service) interface 208 can interface with any type of circuit switching system including a Public Switch Telephone Network (PSTN), a private network (for example a corporate Private Branch Exchange (PBX)) and/or combinations thereof. Thus, POTS interface 208 can include an FXO (Foreign Exchange Office) interface and an FXS (Foreign Exchange Station) interface for receiving information using circuit switching technologies.

IP interface 206 and POTS interface 208 can be embodied in a single device such as an analog telephony adapter (ATA). Other devices that can interface and transport audio data between a computer and a POTS can be used, such as “voice modems” that connect a POTS to a computer using a telephone application program interface (TAPI).

In this manner, agent 120 serves as a bridge between the Internet domain and the POTS domain. In one example, the bridge can be provided at an individual personal computer with a connection to the Internet. Additionally, agent 120 can operate in a peer-to-peer manner with any suitable device, for example device 202 and/or phone 204. Furthermore, agent 120 can communicate with one or more other agents and/or services.

As illustrated in FIG. 2, device 202 and agent 120 are commonly connected, and separately addressable, through a network 210, herein a wide area network such as the Internet. It therefore is not necessary that device 202 and agent 120 be physically located adjacent each other. Device 202 can transmit data, for example speech, text and video data, using a specified protocol to IP interface 206. In one embodiment, communication between client 202 and IP interface 206 uses standardized protocols, for example TCP/IP and SIP with RTP (Session Initiator Protocol with Realtime Transport Protocol).

Access to agent 120 through phone 204 includes connection of phone 204 to a wired or wireless telephone network 212 that, in turn, connects phone 204 to agent 120 through a FXO interface. Alternatively, phone 204 can directly connect to agent 120 through a FXS interface.

Both IP interface 206 and POTS interface 208 connect to agent 120 through a communication application program interface (API) 214. One implementation of communication API 214 is Microsoft Real-Time Communication (RTC) Client API, developed by Microsoft Corporation of Redmond, Wash. Another implementation of communication API 214 is the Computer Supported Telecommunication Architecture (ECMA-269/ISO 120651), or CSTA, an ISO/ECMA standard. Communication API 214 can facilitate multimodal communication applications, including applications for communication between two computers, between two phones and between a phone and a computer. Communication API 214 can also support audio and video calls, text-based messaging and application sharing. Thus, agent 120 is able to initiate communication to device 202 and/or phone 204. Alternatively, another agent and/or service can be contacted by agent 120.

To unify communication control for POTS and IP networks, agent 120 is able to translate POTS protocols into corresponding IP protocols and vice versa. Some of the translations are straightforward. For example, agent 120 is able to translate an incoming phone call from POTS into an invite message (for example a SIP INVITE message) in the IP network, and a disconnect message (for example a SIP BYE message), which corresponds to disconnecting a phone call in POTS.

However, some of the IP-POTS translations involve multiple cohesive steps. For example, a phone call originated in POTS may reach the user on the IP network with agent 120 using an ATA connected to an analog phone line. The user may direct the agent 120 to transfer the communication to a third party reachable only through a POTS using a refer message (for example a SIP REFER message). The ATA fulfills the intent of the SIP REFER message using call transfer conventions for the analog telephone line. Often, call transfer on analog phone lines involves the following steps: (1) generating a hook flash, (2) waiting for a second dial tone, (3) dialing the phone number of the third party recipient, and (4) detecting the analog phone call connection status and generating corresponding SIP messages (e.g., a ringing connection in an analog phone corresponds to a REFER ACCEPTED and a busy tone to a REFER REJECTED, respectively).

Agent 120 also includes a service manager 216, a personal information manager (PIM) 218, a presence manager 220, a personal information and preferences depository 222 and a speech application 224. Service manager 216 includes logic to handle communication requests and messages from communication API 214. This logic can perform several communication tasks including answering, routing and filtering calls, recording voice and video messages, analyzing and storing text messages, arranging calendars, schedules and contacts as well as facilitating individual and conference calls through both IP interface 206 and POTS interface 208.

Service manager 216 also can define a set of rules for which to contact a user and interact with users connecting to agent 120 via communication API 214. Rules that define how to contact a user are referred to as “Find Me/Follow Me” features for communication applications. For example, a user associated with agent 120 can identify a home phone number, an office phone number, a mobile phone number and an email address within personal information and preferences depository 222 for which agent 120 can attempt to contact the user. Additionally, persons contacting agent 120 can have different priority settings such that, for certain persons, calls can always be routed to the user.

Service manager 216 can also perform various natural language processing tasks. For example, service manager 216 can access speech application 224 that includes a recognition engine used to identify features in speech input. Recognition features for speech are usually words in the spoken language. In one particular example, a grammar can be used to recognize text within a speech utterance. As is known, recognition can also be provided for handwriting and/or visual inputs.

Service manager 216 can use semantic objects to access information in PIM 218. As used herein, “semantic” refers to a meaning of natural language expressions. Semantic objects can define properties, methods and event handlers that correspond to the natural language expressions.

A semantic object provides one way of referring to an entity that can be utilized by service manager 216. A specific domain entity pertaining to a particular domain application can be identified by any number of different semantic objects with each one representing the same domain entity phrased in different ways.

The term semantic polymorphism can be used to mean that a specific entity may be identified by multiple semantic objects. The richness of the semantic objects, that is the number of semantic objects, their interrelationships and their complexity, corresponds to the level of user expressiveness that an application would enable in its natural language interface. As an example of polymorphism “John Doe”, “VP of NISD”, and “Jim's manager” all refer to the same person (John Doe) and are captured by different semantic objects PersonByName, PersonByJob, and PersonByRelationship, respectively.

Semantic objects can also be nested and interrelated to one another including recursive interrelations. In other words, a semantic object may have constituents that are themselves semantic objects. For example, “Jim's manager” corresponds to a semantic object having two constituents: “Jim” which is a “Person” semantic object and “Jim's Manager” which is a “PersonByRelationship” semantic object. These relationships are defined by a semantic schema that declares relationships among semantic objects. In one embodiment, the schema is represented as a parent-child hierarchical tree structure. For example, a “SendMail” semantic object can be a parent object having a “recipient” property referencing a particular person that can be stored in PIM 218. Two example child objects can be represented as a “PersonByName” object and a “PersonByRelationship”, object that are used to identify a sender of a mail message from PIN 218.

Using service manager 216, PIM 218 can be accessed based on actions to be performed and/or semantic objects. As appreciated by those skilled in the art, PIM 218 can include various types and structures of data that can manifest themselves in a number of forms such as, but not limited to, relational or objected oriented databases, Web Services, local or distributed programming modules or objects, XML documents or other data representation mechanism with or without annotations, etc. Specific examples include contacts, appointments, text and voice messages, journals and notes, audio files, video files, text files, databases, etc. Agent 120 can then provide an output using communication API 214 based on the data in PIM 218 and actions performed by service manager 216.

PIM 218 can also include an indication of priority settings for particular contacts. The priority settings can include several levels of rules that define how to handle communication messages from a particular contact. For example, one contact can have a high priority (or VIP) setting in which requests and/or messages are always immediately forwarded to the user associated with agent 120. Contacts with a medium priority setting will take a message from the contact if the user is busy and forward an indication of a message received to the user. Contacts with a low setting will have messages taken that can be access by the user at a later time. In any event, numerous settings and rules for a user's contacts can be set within PIM 218, which are not limited to the situations discussed above.

Presence manager 220 includes an indicator of a user's availability. For example, a presence indicator can be “available”, “busy”, “stepped out”, “be right back”, “on the phone”, “online” or “offline”. Presence manager 220 can interact with service manager 216 to handle communication messages based on the indicator. In addition to the presence indicators identified above, presence manager 220 also includes a presence referred to as “delegated presence”.

When presence manager 220 indicates that presence is delegated, agent 120 serves as an automatic message handler for a user or group of users. Agent 120 can automatically interact with persons wishing to contact the user or group of users associated with agent 120. For example, agent 120 can route an incoming call to a user's cell phone, or prompt a person to leave a voicemail message. Alternatively, agent 120 can arrange a meeting with a person based on information contained in a calendar of the PIM 218. When agent 120 is associated with a group of users, agent 120 can route a communication request in a number of different ways. For example, the request can be routed based on a caller identification of a person, based on a dialog with the person or otherwise.

Personal information and preferences depository 222 can include personal information for a particular user including contact information such as email addresses, phone numbers and/or mail addresses. Additionally, depository 222 can include information related to audio and/or electronic books, music, personalized news, weather information, traffic information, stock information and/or services that provide these specific types of information.

Additionally, depository 222 can include customized information to drive speech application 224. For example, depository 222 can include acoustic models, user voice data, voice services that a user wishes to access, a history of user behavior, models that predict user behavior, modifiable grammars for voice services, personal data such as log-in names and passwords and/or voice commands.

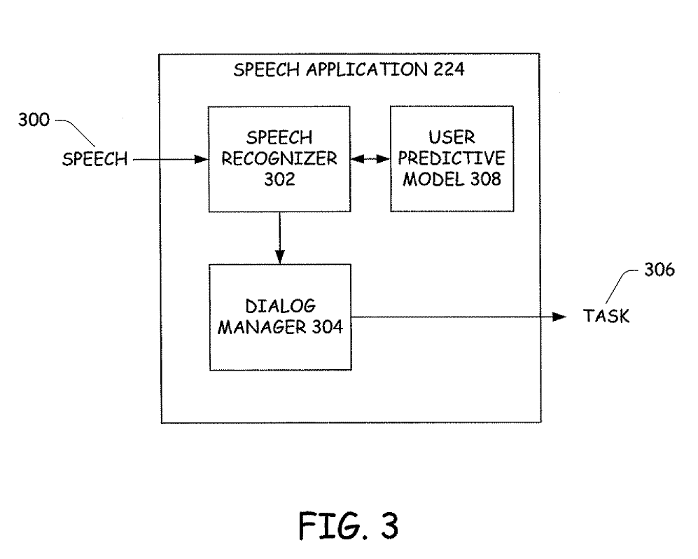

FIG. 3 is a simplified block diagram of speech application 224. Speech 300 is input into speech application 224 through the communication modes discussed above with regards to FIG. 2. Speech 300 is then sent to speech recognizer 302. Speech recognizer 302 will produce one or more recognition results that correspond to content of what was spoken in speech 300. Dialog manager 304 receives the one or more recognition results from speech recognizer 302 and proceeds to perform one or more tasks 306. These tasks can include rendering information to a user, forming a connection with another user and/or conducting a dialog with the user, for example.

If the user would like weather information rendered, the user can speak “weather” or “what is the forecast?” Speech application 224 can interpret this speech and audibly render related weather information based on information in depository 222, which could be a location, a particular weather service for which to get the weather information and/or a model within speech application 224.

Additionally, agent 120 can form a voice connection with another user based on speech. If a user speaks, “call Kim”, speech application 224 recognizes the result and service manager 216 can access information for the contact “Kim” and form a connection based on the information.

Speech application 224 can also maintain speech 300 received from the user in order to provide a more personalized speech application 224 for the user. Additionally, history of tasks performed by dialog manager 304 can be maintained, for example in personal information and preferences depository 222, to further personalize speech application 224.

A user's history can also be used to modify speech application 224 by using a predictive user model 308. For example, if a user history notes that the user checks email using agent 120 often, a task that opens email can be assigned a higher probability than tasks that are performed less often. Thus, speech application 224 is more likely to associate speech input with the task that opens email.

Predictive user model 308 can be a statistical model that is used to predict a task based, at least in part, on past user behavior. For example, if a particular user calls a spouse at the end of every work day, the predictor model can be adapted to weight that spouse more than other contacts during that time.

In model 308, a two-part model can be used to associate speech 300 with task 306. For example, one part can be associated with the particular task (i.e., make a call, locate a particular service, access a calendar, etc.) and another part can be of particular portion of data associated with the task (i.e., a particular contact entity, a location for weather information, a particular stock, etc.). Model 308 can assign probabilities to both the task and/or the particular portion of data associated with the task. These probabilities can be either dependent or independent of one another and based on features indicative of the user's history. In addition, the probabilities can be used in combination with output from speech recognizer 302, wherein any type of combination can be used.

User predictive model 308 can employ features for predicting the user's task which can be stored in depository 222. Any type of feature model can be used to train and/or modify predictive user model 308. For example, an independent feature model can be used based on features that can be time related, task related, contact specific and/or periodic. Such features can relate to a day of the week, a time of the day, a frequency of a particular task, a frequency of a particular contact, etc. Any type of learning method can be employed to train and/or update predictive user model 308. Such learning methods include support vector machines, decision tree learning, etc.

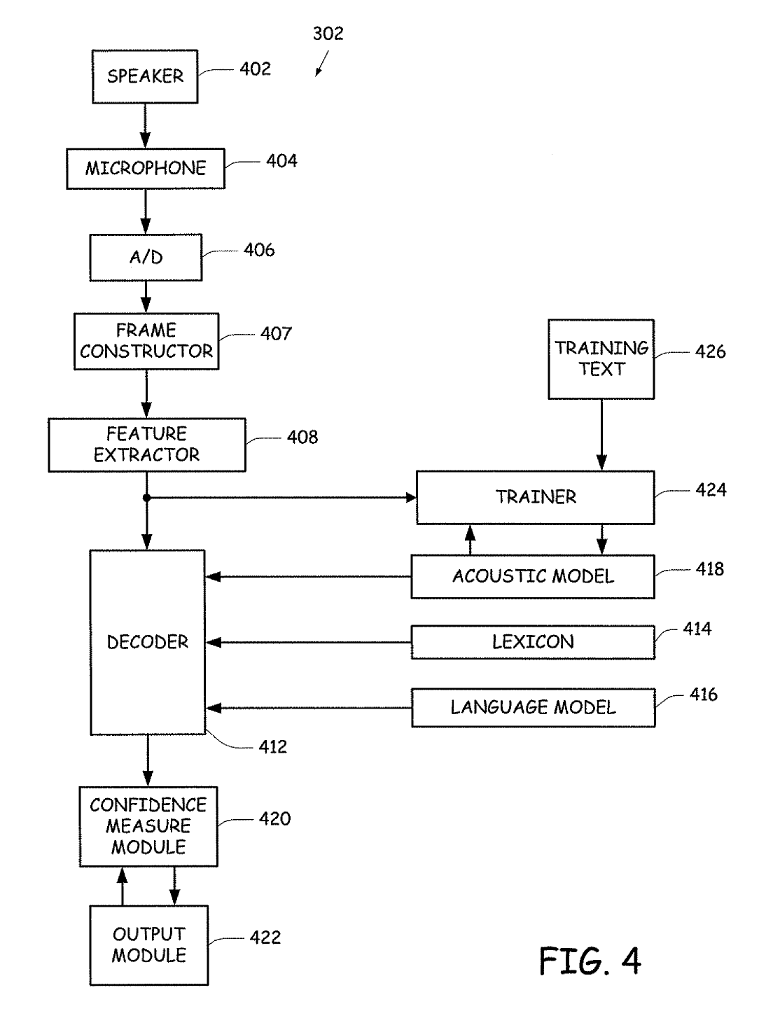

FIG. 4 provides a block diagram of speech recognizer 302. In FIG. 4, a speaker 402, either a trainer or a user, speaks into a microphone 404, for example one that is provided on device 202 or phone 204. The audio signals detected by microphone 404 are converted into electrical signals that are provided to analog-to-digital converter 406.

A-to-D converter 406 converts the analog signal from microphone 404 into a series of digital values. In several embodiments, A-to-D converter 406 samples the analog signal at 16 kHz and 16 bits per sample, thereby creating 32 kilobytes of speech data per second. These digital values are provided to a frame constructor 407, which, in one embodiment, groups the values into 25 millisecond frames that start 10 milliseconds apart.

The frames of data created by frame constructor 407 are provided to feature extractor 408, which extracts a feature from each frame. Examples of feature extraction modules include modules for performing Linear Predictive Coding (LPC), LPC derived cepstrum, Perceptive Linear Prediction (PLP), auditory model feature extraction, and Mel-Frequency Cepstrum Coefficients (MFCC) feature extraction. Note that recognizer 302 is not limited to these feature extraction modules and that other modules may be used within the context of recognizer 302.

The feature extraction module 408 produces a stream of feature vectors that are each associated with a frame of the speech signal. This stream of feature vectors is provided to a decoder 412, which identifies a most likely sequence of words based on the stream of feature vectors, a lexicon 414, a language model 416 (for example, based on an N-gram, context-free grammars, or hybrids thereof), and an acoustic model 418.

The most probable sequence of hypothesis words is provided to a confidence measure module 420. Confidence measure module 420 identifies which words are most likely to have been improperly identified by the speech recognizer, based in part on a secondary acoustic model (not shown). Confidence measure module 420 then provides the sequence of hypothesis words to an output module 422 along with identifiers indicating which words may have been improperly identified. Those skilled in the art will recognize that confidence measure module 420 is not necessary for the operation of recognizer 302.

During training, a speech signal corresponding to training text 426 is input to trainer 424, along with a lexical transcription of the training text 426. Trainer 424 trains acoustic model 418 based on the training inputs. A user can train acoustic model 418 utilizing communication architecture 200 in FIG. 2. For example, a user can train acoustic model 218 using a desktop computer and/or mobile device at a convenient time, which aids in improving a recognition rate for speech application 224.

In addition to training acoustic model 418, a user can also modify prompts played by speech application 224 as well as lexicon 414 and language model 416. For example, a user can specify utterances that will perform a particular task. A user can thus establish a grammar wherein the utterances “calendar”, “open calendar” or “check calendar” will all open a calendar within personal information manager 218. In one example, these utterances can be included as elements of a context free grammar in language model 416. In another example, these utterances can be combined in an N-gram or unified language model.

The user can also modify DTMF (dual tone multi-frequency) tone settings. Thus, a user can associate the number 1 on a phone keypad with email, 2 with a calendar, etc.

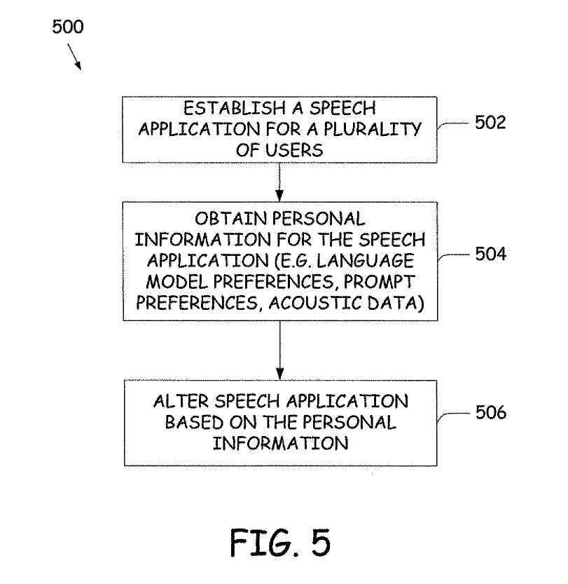

FIG. 5 is a flow chart of a method 500 for altering a speech application as discussed above. At step 502, a speech application is established for a plurality of users. This application can be a speaker independent application that is established each time a user registers with service agent 120. Personal information is obtained for the speech application at step 504. This personal information includes language model preferences, prompt preferences, acoustic data, etc. A user can enter this information using device 202 and/or phone 204. For example, a user may use device 202 to enter text into a grammar that is associated with a particular task. Furthermore, the user can utilize phone 204 to access what commands are associated with particular tasks and/or alter utterances that are associated with particular tasks, either by using a voice interface or through DTMF. At step 506, the speech application is altered based on the person information. The altering can be continued such that each time a user accesses speech application 224, more data is maintained to improve performance of the speech application.

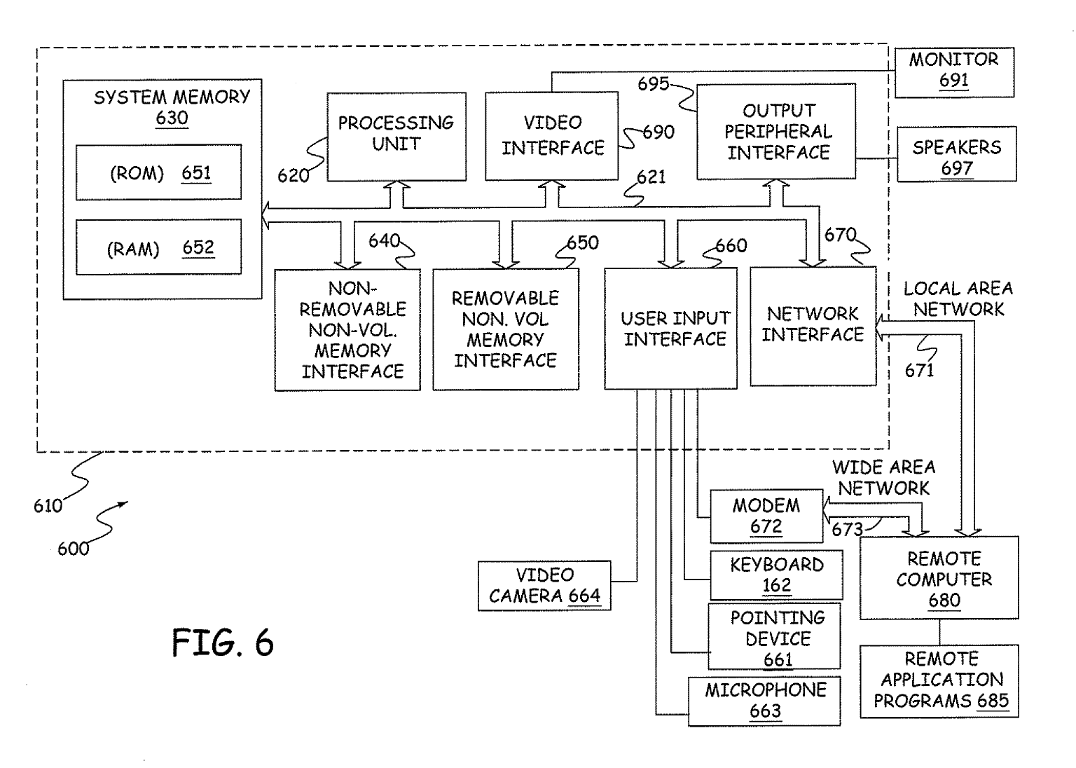

The above description of illustrative embodiments is described in accordance with a network-based service environment having a service agent and client devices. Below are suitable computing environments that can incorporate and benefit from these embodiments. The computing environment shown in FIG. 6 is one such example that can be used to implement the service agent and/or be implemented as a client device.

In FIG. 6, the computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary computing environment 600.

Computing environment 600 illustrates a general purpose computing system environment or configuration. Examples of well-known computing systems, environments, and/or configurations that may be suitable for use with the service agent or a client device include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Concepts presented herein may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

Exemplary environment 600 for implementing the above embodiments includes a general-purpose computing system or device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

The system memory 630 includes computer storage media in the form of volatile and/or nonvolatile memory such as read only memory (ROM) 131 and random access memory (RAM) 632. The computer 610 may also include other removable/non-removable volatile/nonvolatile computer storage media. Non-removable non-volatile storage media are typically connected to the system bus 621 through a non-removable memory interface such as interface 640. Removeable non-volatile storage media are typically connected to the system bus 621 by a removable memory interface, such as interface 650.

A user may enter commands and information into the computer 610 through input devices such as a keyboard 662, a microphone 663, a pointing device 661, such as a mouse, trackball or touch pad, and a video camera 664. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690. In addition to the monitor, computer 610 may also include other peripheral output devices such as speakers 697, which may be connected through an output peripheral interface 695.

The computer 610, when implemented as a client device or as a service agent, is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between computers may be used.

Besides computer 610 being used as a client device, mobile devices can also be used as client devices. Mobile devices can be used in various computing settings to utilize service agent 216 across the network-based environment. For example, mobile devices can interact with service agent 216 using natural language input of different modalities including text and speech. The mobile device as discussed below is exemplary only and is not intended to limit the present invention described herein.

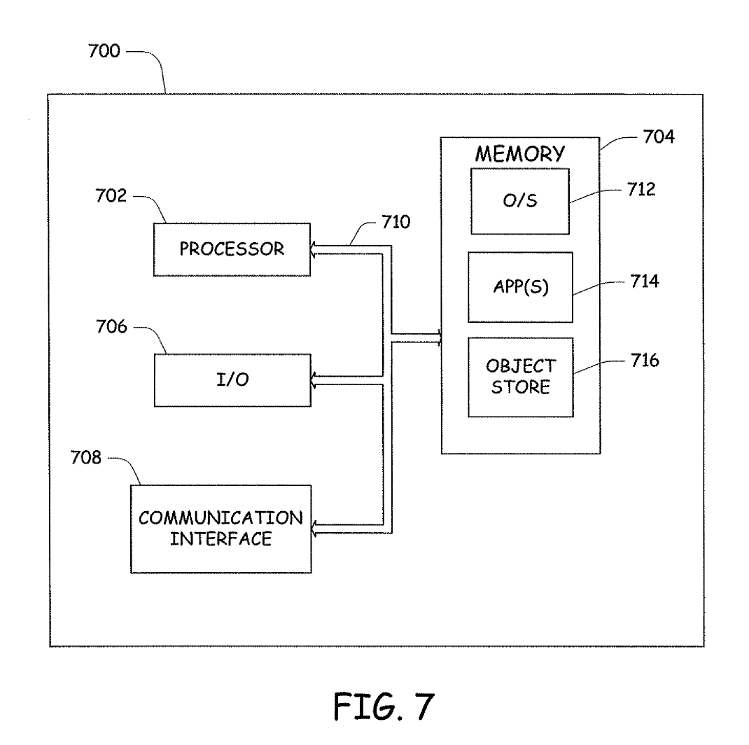

FIG. 7 is a block diagram of a data management mobile device 700, which is an exemplary client device for the network-based service environment 100. Mobile device 700 includes a microprocessor 702, memory 704, input/output (I/O) components 706, and a communication interface 708 for communicating with remote computers or other mobile devices. In one embodiment, the aforementioned components are coupled for communication with one another over a suitable bus 710.

Memory 704 is implemented as non-volatile electronic memory such as random access memory (RAM) with a battery backup module (not shown) such that information stored in memory 704 is not lost when the general power to mobile device 700 is shut down. A portion of memory 704 is preferably allocated as addressable memory for program execution, while another portion of memory 704 is preferably used for storage, such as to simulate storage on a disk drive.

Communication interface 708 represents numerous devices and technologies that allow mobile device 700 to send and receive information. The devices include wired and wireless modems, satellite receivers and broadcast tuners to name a few. Mobile device 700 can also be directly connected to a computer to exchange data therewith. In such cases, communication interface 708 can be an infrared transceiver or a serial or parallel communication connection, all of which are capable of transmitting streaming information.

Input/output components 706 include a variety of input devices such as a touch-sensitive screen, buttons, rollers, and a microphone as well as a variety of output devices including an audio generator, a vibrating device, and a display. The devices listed above are by way of example and need not all be present on mobile device 700. In addition, other input/output devices may be attached to or found with mobile device 700.

Mobile device 700 can also include an optional recognition program (speech, DTMF, handwriting, gesture or computer vision) stored in memory 704. By way of example, in response to audible information, instructions or commands from a microphone provides speech signals, which are digitized by an A/D converter. The speech recognition program can perform normalization and/or feature extraction functions on the digitized speech signals to obtain intermediate speech recognition results. Similar processing can be used for other forms of input. For example, handwriting input can be digitized with or without pre-processing on device 700. Like the speech data, this form of input can be transmitted to a server for recognition wherein the recognition results are returned to at least one of the device 700 and/or a remote agent. Likewise, DTMF data, gesture data and visual data can be processed similarly. Depending on the form of input, device 700 would include necessary hardware such as a camera for visual input.

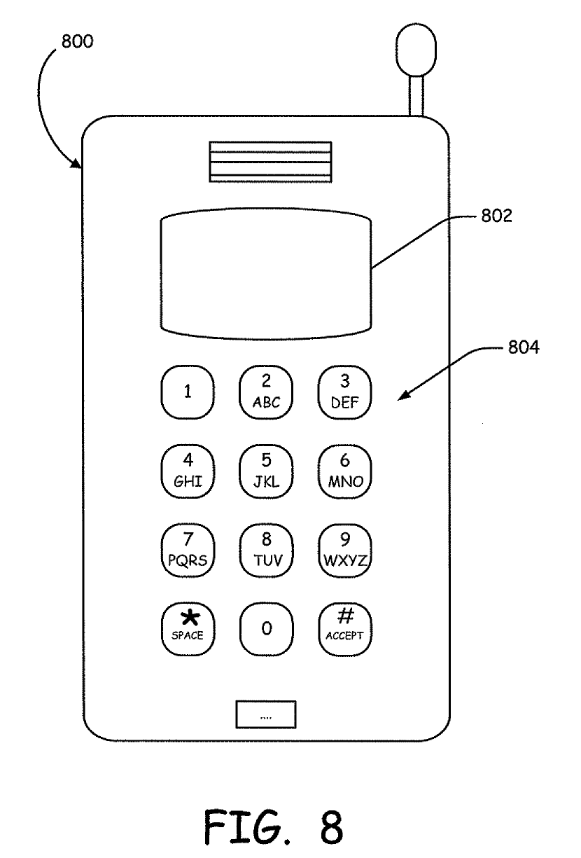

FIG. 8 is a plan view of an exemplary embodiment of a portable phone 800. The phone 800 includes a display 802 and a keypad 804. Generally, the block diagram of FIG. 7 applies to the phone of FIG. 8, although additional circuitry necessary to perform other functions may be required. For instance, a transceiver necessary to operate as a phone will be required for the embodiment of FIG. 7.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
establishing a speech application accessible across a network for a plurality of users;
storing separate preferences for each of the plurality of users related to the speech application; and
altering the speech application based on each of the separate preferences.

2. The method of claim 1 wherein the preferences relate to a grammar for the speech application.

3. The method of claim 1 wherein the preferences relate to a prompt for the speech application.

4. The method of claim 1 wherein the speech application includes an acoustic model and wherein the speech application is further altered based on speech input from each of the plurality of users.

5. The method of claim 1 wherein the preferences relate to a lexicon of the speech application.

6. The method of claim 1 wherein the preferences relate to a history of user behavior for each of the plurality of users.

7. The method of claim 1 wherein the preferences relate to commands for the speech application.

8. The method of claim 1 and further comprising storing DTMF associations for commands.

9. A system, comprising:
a speech application;
a data store for storing preferences for a user related to the speech application;
a communication application programming interface for receiving information from the user related to the preferences across a network; and
a module adapted to alter the preferences based on the information received and alter the speech application based on the preferences.

10. The system of claim 9 wherein the preferences related to a grammar for the speech application.

11. The system of claim 9 wherein the preferences related to a prompt for the speech application.

12. The system of claim 9 wherein the speech application includes an acoustic model and wherein the speech application is further altered based on speech input from the user.

13. The system of claim 9 wherein the preferences relate to a history of user behavior of the user.

14. The system of claim 13 and further comprising wherein the preferences relate to a probability for a task based on the history.

15. A method, comprising:
establishing a speech application for access across a network, the speech application including an acoustic model and a language model;
rendering information across the network to a user that is related to at least one of the acoustic model and the language model;
allowing the user to modify at least one of the acoustic model and the language model based on the rendered information; and
modifying operation of the speech application based on modifications by the user.

16. The method of claim 15 wherein allowing the user further comprises training the acoustic model, adding language to the language model and associating the added language to a particular task.

17. The method of claim 15 wherein allowing the user further comprises providing access using an internet protocol network and a plain old telephone system network.

18. The method of claim 15 wherein modifying operation includes assigning probabilities to tasks identified by the speech application based on a history of the user.

19. The method of claim 15 wherein modifying operation includes adjusting prompts for the speech application.

20. The method of claim 15 and further comprising allowing a user to modify DTMF associations.
